(19) United States
(12) Patent Application Publication
(10) Pub. No.: US 2024/0014944 A1
(43) Pub. Date: Jan. 11, 2024

(54) METHOD AND DEVICE IN NODES USED FOR WIRELESS COMMUNICATION

(71) Applicants: Yang HU, Shanghai (CN); Xiaobo ZHANG, Shanghai (CN)

(72) Inventors: Yang HU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/372,802

(22) Filed: Sep. 26, 2023

Related U.S. Application Data
(63) Continuation of application No. PCT/CN2022/082066, filed on Mar. 21, 2022.

(30) Foreign Application Priority Data
Mar. 29, 2021 (CN) 202110333493.0

(51) Int. Cl. H04L 1/1812; H04L 5/00

(52) U.S. Cl. CPC H04L 1/1812; H04L 5/0005

(57) ABSTRACT

The present application discloses a method and a device in a node for wireless communications. A first receiver, receives a first signaling; respectively receives M bit blocks on the M physical channels, M being a positive integer greater than 1; a first transmitter transmits a first signal in a target time unit, the first signal carries a first HARQ-ACK bit block; herein, the first signaling is used to indicate first-type bit block(s) in the M bit blocks, and a number of the first-type bit block(s) in the M bit blocks is a positive integer less than M; the M physical channels are mapped to transport channel(s) of a same type; the first signaling indicates configuration information of the M physical channels; the first signaling indicates a first time-domain offset.

### CROSS REFERENCE TO RELATED APPLICATIONS

This application is the continuation of the international patent application No. PCT/CN2022/082066, filed on Mar. 21, 2022, and claims the priority benefit of Chinese Patent Application No. 202110333493.0, filed on Mar. 29, 2021, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks or non-territorial networks.

### Related Art

In 5G NR system, in order to support wireless communications in high-frequency frequency band (such as the frequency band between 52.6 GHz and 71 GHz), 3GPP considers supporting a scheduling method of scheduling multiple Physical Downlink Shared CHannel (PDSCH) receptions with one Downlink Control Information (DCI) signaling in NR Release 17 version. 3GPP supports the configuration of HARQ feedback enabling/disabling for HARQ process in NR Release 17.

### SUMMARY

When a part of multiple PDSCH receptions scheduled by a DCI corresponds to a HARQ process available for a HARQ feedback, and rest part corresponds to a HARQ process of HARQ feedback disabling, how to determine a slot (or, a sub-slot) of a HARQ feedback for the part of the multiple PDSCH receptions corresponding to a HARQ process available for a HARQ feedback is an important issue to be addressed.

To address the above problem, the present application provides a solution. In the above problem description, wireless communications on high-frequency frequency band is used as an example; the present application is also applicable to other scenarios, such as wireless communications on low-frequency band, non-terrestrial networks (NTN), Internet of Vehicles, Internet of Things (IoT), or other transmission scenarios related to HARQ feedback, where similar technical effects can be achieved. In addition, adopting a unified solution for different scenarios (including but not limited to wireless communications on high-frequency frequency band, wireless communications on low-frequency frequency band, cellular network, NTN, IoV, IoT) can also help reduce hardware complexity and cost. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first signaling; respectively receiving M bit blocks on M physical channels, M being a positive integer greater than 1; and
transmitting a first signal in a target time unit, the first signal carrying a first HARQ-ACK bit block;
herein, the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling indicates configuration information of the M physical channels, and the configuration information comprises at least one of occupied time-domain resources, occupied frequency-domain resources, HARQ process number, RV or MCS; the first signaling indicates a first time-domain offset, and a latest physical channel accommodating the first-type bit block among the M physical layer channels is used together with the first time-domain offset to determine the target time unit.

In one embodiment, a problem to be solved in the present application comprises: when a part of multiple PDSCH receptions scheduled by a DCI corresponds to a HARQ process available for a HARQ feedback, and rest part corresponds to a HARQ process of HARQ feedback disabling, how to determine a time unit (such as a slot or a sub-slot) reported by related Hybrid Automatic Repeat reQuest Acknowledgement (HARQ-ACK).

In one embodiment, a problem to be solved in the present application comprises: how to interpret the meaning of the first time-domain offset indicated by the first signaling.

In one embodiment, essence of the above method comprises: the meaning of the first time-domain offset indicated by the first signaling is associated with a latest physical channel accommodating the first-type bit block among the M physical channels.

In one embodiment, advantages of the above method include: being conducive to reducing the delay of HARQ feedback.

In one embodiment, advantages of the above method include: being conducive to leverage advantages of two technologies of single DCI scheduling multiple PDSCH receptions and HARQ feedback enabling/disabling.

In one embodiment, advantages of the above method include: providing a reasonable and efficient timing indication method.

According to one aspect of the present application, the above method is characterized in that

the first signaling indicates HARQ process numbers corresponding to the M bit blocks, and which bit block in the M bit blocks is the first-type bit block is related to the HARQ process numbers corresponding to the M bit blocks.

According to one aspect of the present application, the above method is characterized in that

a HARQ process number corresponding to any of the M bit blocks belongs to a first HARQ process number set; a first HARQ process number subset is a proper subset of the first HARQ process number set; the first-type bit block refers to: a bit block with a HARQ process number belonging to the first HARQ process number subset.

In one embodiment, essence of the above method comprises: a HARQ process number corresponding to the M bit blocks indicated by the first signaling is used to determine a time unit to which a Physical Uplink Control Channel (PUCCH) reserved for a corresponding HARQ-ACK information transmission belongs.

According to one aspect of the present application, the above method is characterized in that

HARQ process numbers in the first HARQ process number subset are all HARQ process numbers for enabled HARQ feedback, and any HARQ process number in the first HARQ process number set not belonging to the first HARQ process number subset is a HARQ process number for disabled HARQ feedback.

According to one aspect of the present application, the above method is characterized in that

a number of time unit(s) between a start time of the target time unit and a start time of a time unit to which an end time of the latest physical channel accommodating the first-type bit block among the M physical channels in time domain belongs is equal to the first time-domain offset.

According to one aspect of the present application, the above method is characterized in that

the target time unit is earlier than a time unit to which an end time of one of the M physical channels in time domain belongs.

In one embodiment, advantages of the above method include: there is no need to wait until all the M bit blocks are received before feeding back HARQ-ACK information bits, thus reducing the transmission delay.

According to one aspect of the present application, the above method is characterized in that

a number of HARQ-ACK bit sub-block(s) comprised in the first HARQ-ACK bit block is related to the first HARQ process number subset; any HARQ-ACK bit sub-block in the first HARQ-ACK bit block is associated with at most one physical channel.

In one embodiment, advantages of the above method include: being conducive to reducing the overhead of HARQ-ACK feedback.

The present application provides a method in a second node for wireless communications, comprising:
transmitting a first signaling; respectively transmitting the M bit blocks on the M physical channels, M being a positive integer greater than 1; and
receiving a first signal in a target time unit, the first signal carrying a first HARQ-ACK bit block;
herein, the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling indicates configuration information of the M physical channels, and the configuration information comprises at least one of occupied time-domain resources, occupied frequency-domain resources, HARQ process number, RV or MCS; the first signaling indicates a first time-domain offset, and a latest physical channel accommodating the first-type bit block among the M physical layer channels is used together with the first time-domain offset to determine the target time unit.

According to one aspect of the present application, the above method is characterized in that

the first signaling indicates HARQ process numbers corresponding to the M bit blocks, and which bit block in the M bit blocks is the first-type bit block is related to the HARQ process numbers corresponding to the M bit blocks.

According to one aspect of the present application, the above method is characterized in that

a HARQ process number corresponding to any of the M bit blocks belongs to a first HARQ process number set; a first HARQ process number subset is a proper subset of the first HARQ process number set; the first-type bit block refers to: a bit block with a HARQ process number belonging to the first HARQ process number subset.

According to one aspect of the present application, the above method is characterized in that

HARQ process numbers in the first HARQ process number subset are all HARQ process numbers for enabled HARQ feedback, and any HARQ process number in the first HARQ process number set not belonging to the first HARQ process number subset is a HARQ process number for disabled HARQ feedback.

According to one aspect of the present application, the above method is characterized in that a number of time unit(s) between a start time of the target time unit and a start time of a time unit to which an end time of the latest physical channel accommodating the first-type bit block among the M physical channels in time domain belongs is equal to the first time-domain offset.

According to one aspect of the present application, the above method is characterized in that

the target time unit is earlier than a time unit to which an end time of one of the M physical channels in time domain belongs.

According to one aspect of the present application, the above method is characterized in that

a number of HARQ-ACK bit sub-block(s) comprised in the first HARQ-ACK bit block is related to the first HARQ process number subset; any HARQ-ACK bit sub-block in the first HARQ-ACK bit block is associated with at most one physical channel.

The present application provides a first node for wireless communications, comprising:
a first receiver, receiving a first signaling; respectively receiving M bit blocks on M physical channels, M being a positive integer greater than 1; and
a first transmitter, transmitting a first signal in a target time unit, the first signal carrying a first HARQ-ACK bit block;
herein, the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling indicates configuration information of the M physical channels, and the configuration information comprises at least one of occupied time-domain resources, occupied frequency-domain resources, HARQ process number, RV or MCS; the first signaling indicates a first time-domain offset, and a latest physical channel accommodating the first-type bit block among the M physical layer channels is used together with the first time-domain offset to determine the target time unit.

The present application provides a second node for wireless communications, comprising:
a second transmitter, transmitting a first signaling; respectively transmitting the M bit blocks on the M physical channels, M being a positive integer greater than 1; and
a second receiver, receiving a first signal in a target time unit, the first signal carrying a first HARQ-ACK bit block;
herein, the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling indicates configuration information of the M physical channels, and the configuration information comprises at least one of occupied time-domain resources, occupied frequency-domain resources, HARQ process number, RV or MCS; the first signaling indicates a first time-domain offset, and a latest physical channel accommodating the first-type bit block among the M physical layer channels is used together with the first time-domain offset to determine the target time unit.

In one embodiment, the method in the present application is advantageous in the following aspects:
it is conducive to ensuring the delay performance of transmission;
it is conducive to the combination of two technologies of single DCI scheduling multiple PDSCH receptions and HARQ feedback enabling/disabling as well as leverage their respective advantages.
it provides an effective timing indication method;
there is no need to wait until all the M bit blocks are received before feeding back HARQ-ACK information bits, thus reducing the transmission delay.
it is conducive to reducing the overhead of HARQ-ACK feedback.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of signal transmission according to one embodiment of the present application;

FIG. 6 illustrates a schematic diagram of relations among a first signaling, HARQ process numbers corresponding to M bit blocks, a first HARQ process number set, a first HARQ process number subset and a first-type bit block according to one embodiment of the present application;

FIG. 7 illustrates a schematic diagram of a target time unit according to one embodiment of the present application;

FIG. 8 illustrates a schematic diagram of a target time unit according to one embodiment of the present application;

FIG. 9 illustrates a schematic diagram of a relation between a number of HARQ-ACK bit sub-block(s) comprised in a first HARQ-ACK bit block and a first HARQ process number subset according to one embodiment of the present application;

FIG. 10 illustrates a structure block diagram of a processor in a first node according to one embodiment of the present application;

FIG. 11 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

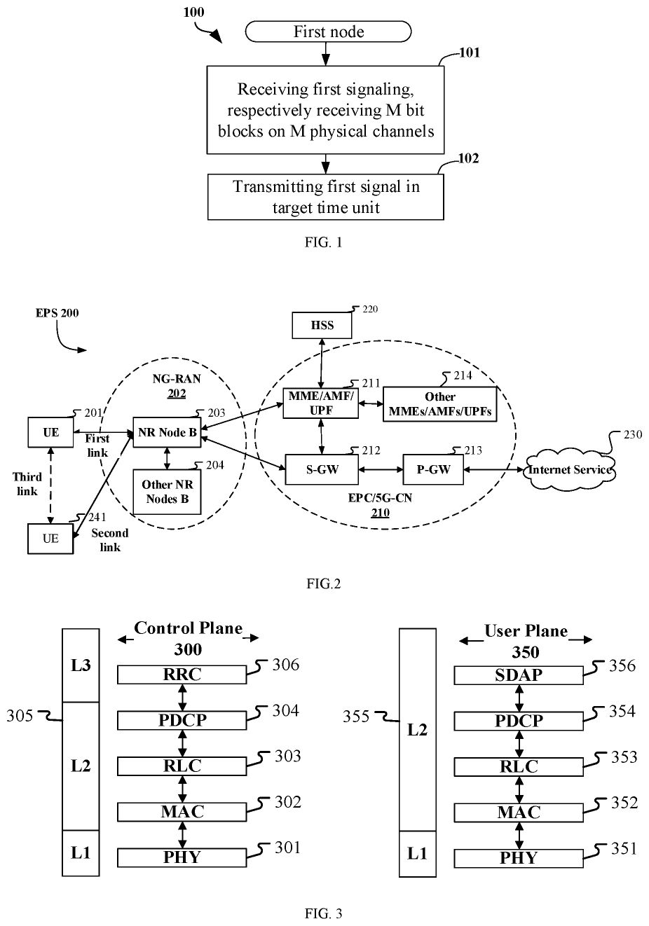

Embodiment 1 illustrates a flowchart of the processing of a first node according to one embodiment of the present application, as shown in FIG. 1.

In Embodiment 1, the first node in the present application receives a first signaling in step 101, and respectively receives M bit blocks on the M physical channels; transmits a first signal in a target time unit in step 102.

In embodiment 1, M is a positive integer greater than 1; the first signal carries a first HARQ-ACK bit block; the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling indicates configuration information of the M physical channels, and the configuration information comprises at least one of occupied time-domain resources, occupied frequency-domain resources, HARQ process number, RV or MCS; the first signaling indicates a first time-domain offset, and a latest physical channel accommodating the first-type bit block among the M physical layer channels is used together with the first time-domain offset to determine the target time unit.

In one embodiment, the first signaling is dynamically configured.

In one embodiment, the first signaling comprises a layer 1 (L1) signaling.

In one embodiment, the first signaling comprises an L1 control signaling.

In one embodiment, the first signaling comprises a physical layer signaling.

In one embodiment, the first signaling comprises one or multiple fields in a physical layer signaling.

In one embodiment, the first signaling comprises a higher-layer signaling.

In one embodiment, the first signaling comprises one or multiple fields in a higher-layer signaling.

In one embodiment, the first signaling comprises a Radio Resource Control (RRC) signaling.

In one embodiment, the first signaling comprises a Medium Access Control layer Control Element (MAC CE) signaling.

In one embodiment, the first signaling comprises one or multiple fields in an RRC signaling.

In one embodiment, the first signaling comprises one or multiple fields in a MAC CE signaling.

In one embodiment, the first signaling comprises Downlink Control Information (DCI).

In one embodiment, the first signaling comprises one or multiple fields in a DCI.

In one embodiment, the first signaling is a DCI.

In one embodiment, the first signaling comprises Sidelink Control Information (SCI).

In one embodiment, the first signaling comprises one or multiple fields in an SCI.

In one embodiment, the first signaling comprises one or multiple fields in an Information Element (IE).

In one embodiment, the first signaling is a DownLink Grant Signalling.

In one embodiment, the first signaling is an UpLink Grant Signalling.

In one embodiment, the first signaling is transmitted on a downlink physical layer control channel (i.e., a downlink channel only capable of carrying a physical layer signaling).

In one embodiment, the downlink physical-layer control channel in the present application is a Physical Downlink Control CHannel (PDCCH).

In one subembodiment of the above embodiment, the downlink physical layer control channel in the present application is a short PDCCH (sPDCCH).

In one embodiment, the downlink physical layer control channel in the present application is a Narrow Band PDCCH (NB-PDCCH).

In one embodiment, the first signaling is DCI format 1_0, and for the specific meaning of the DCI format 1_0, refer to section 7.3.1.2 in 3GPP TS38.212.

In one embodiment, the first signaling is DCI format 1_1, and for the specific meaning of the DCI format 1_1, refer to section 7.3.1.2 in 3GPP TS38.212.

In one embodiment, the first signaling is DCI format 1_2, and for the specific meaning of the DCI format 1_2, refer to section 7.3.1.2 in 3GPP TS38.212.

In one embodiment, the first signaling is DCI format 0_0, and for the specific meaning of the DCI format 0_0, refer to section 7.3.1.1 in 3GPP TS38.212.

In one embodiment, the first signaling is DCI format 0_1, and for the specific meaning of the DCI format 0_1, refer to section 7.3.1.1 in 3GPP TS38.212.

In one embodiment, the first signaling is DCI format 0_2, and for the specific meaning of the DCI format 0_2, refer to section 7.3.1.1 in 3GPP TS38.212.

In one embodiment, the first signal in the present application comprises a radio signal.

In one embodiment, the first signal in the present application comprises a radio frequency signal.

In one embodiment, the first signal in the present application comprises a baseband signal.

In one embodiment, the M physical channels in the present application are respectively M Physical Downlink Share CHannels (PDSCHs).

In one embodiment, the M physical channels in the present application are respectively M Physical Sidelink Shared CHannels (PSSCHs).

In one embodiment, the M physical channels do not overlap with each other in time domain.

In one embodiment, M is one of 2, 3, 4, 5, 6, 7 and 8.

In one embodiment, M is a positive integer between 2 and 256.

In one embodiment, the M bit blocks comprise M1 first-type bit block(s) and M2 second-type bit block(s); M is equal to M1 plus M2, both of M1 and M2 are positive integers, and the second-type bit block is different from the first-type bit block.

In one embodiment, one of the M bit blocks comprises at least one bit.

In one embodiment, one of the M bit blocks comprises a code block.

In one embodiment, one of the M bit blocks comprises at least one Code Block Group (CBG).

In one embodiment, any of the M bit blocks comprises a Transport Block (TB).

In one embodiment, the first HARQ-ACK bit block comprises at least one HARQ-ACK bit.

In one embodiment, the first HARQ-ACK bit block comprises a HARQ-ACK codebook or sub-codebook.

In one embodiment, the first HARQ-ACK bit block comprises a Type-1 HARQ-ACK codebook.

In one embodiment, the first HARQ-ACK bit block comprises a Type-2 HARQ-ACK codebook.

In one embodiment, the first signaling is used to explicitly indicate the first-type bit block in the M bit blocks.

In one embodiment, the first signaling is used to implicitly indicate the first-type bit block in the M bit blocks.

In one embodiment, the first signaling indicates an MCS corresponding to the M bit blocks, and which of the M bit blocks is the first-type bit block is determined based on the MCS corresponding to the M bit blocks.

In one embodiment, the first signaling indicates an RV corresponding to the M bit blocks, and which of the M bit blocks is the first-type bit block is determined based on the RV corresponding to the M bit blocks.

In one embodiment, the M physical channels are mapped to a Downlink Shared Channel (DL-SCH).

In one embodiment, the M physical channels are mapped to an Uplink Shared CHannel (UL-SCH).

In one embodiment, the M physical channels are mapped to a Broadcast Channel (BCH).

In one embodiment, the same type of transport channel in the present application refers to: a DL-SCH.

In one embodiment, the same type of transport channel in the present application refers to: a BCH.

In one embodiment, the same type of transport channel in the present application refers to: a Paging CHannel (PCH).

In one embodiment, the same type of transport channel in the present application refers to: a Sidelink Shared CHannel (SL-SCH).

In one embodiment, in the present application, the meaning of the first node receiving a bit block on a physical channel comprises: the physical channel is a PDSCH, and the first node executes a PDSCH reception for the PDSCH.

In one embodiment, the meaning of the expression of respectively receiving M bit blocks on the M physical channels comprises: respectively executing M PDSCH receptions for M PDSCHs, the M PDSCHs being respectively used to accommodate the M bit blocks.

In one embodiment, the first HARQ-ACK bit block comprises HARQ-ACK information bits for the first-type bit block in the M bit blocks.

In one embodiment, the first HARQ-ACK bit block comprises a HARQ-ACK information bit indicating whether the first-type bit block in the M bit blocks is correctly received.

In one embodiment, the first HARQ-ACK bit block does not comprise a HARQ-ACK information bit for a bit block other than the first-type bit block in the M bit blocks.

In one embodiment, the RV in the present application refers to Redundancy Version.

In one embodiment, the MCS in the present application refers to a Modulation and Coding Scheme.

In one embodiment, the first signaling explicitly indicates the first time-domain offset.

In one embodiment, the first signaling implicitly indicates the first time-domain offset.

In one embodiment, a PDSCH-to-HARQ feedback timing indicator comprised in the first signaling indicates the first time-domain offset.

In one embodiment, a start time of a latest physical channel accommodating the first-type bit block among the M physical layer channels in time domain is used together with the first time-domain offset to determine the target time unit.

In one embodiment, an end time of a latest physical channel accommodating the first-type bit block among the M physical layer channels in time domain is used together with the first time-domain offset to determine the target time unit.

In one embodiment, a latest physical channel accommodating the first-type bit block among the M physical layer channels and the first time-domain offset indicate the target time unit together.

In one embodiment, a sum of a time-domain index corresponding to a latest physical channel accommodating the first-type bit block among the M physical layer channels and the first time-domain offset indicates the target time unit together.

In one embodiment, a number of time unit(s) between a start time of the target time unit and a start time of a time unit to which an end time of the latest physical channel accommodating the first-type bit block among the M physical channels in time domain belongs is not less than the first time-domain offset.

In one embodiment, a number of time unit(s) between a start time of the target time unit and a start time of a time unit to which an end time of the latest physical channel accommodating the first-type bit block among the M physical channels in time domain belongs is equal to the first time-domain offset plus a time unit of a constant; the constant is a positive integer configured for a higher-layer signaling.

In one embodiment, a time unit to which an end time of the latest physical channel accommodating the first-type bit block among the M physical channels in time domain belongs among the M physical channels is time unit n, the first time-domain offset is equal to k, and the time unit is time unit n+k; the k is a non-negative integer.

In one embodiment, in the present application, a physical channel accommodating a (first-type) bit block refers to: the (first-type) bit block is transmitted in the physical channel.

In one embodiment, the phrase that the first signal carries a first HARQ-ACK bit block comprises that: the first signal comprises an output after all or part of bits in the first HARQ-ACK bit block sequentially through part or all of an CRC Insertion, Segmentation, Code Block-level CRC Insertion, Channel Coding, Rate Matching, Concatenation, Scrambling, Modulation, Layer Mapping, Precoding, Mapping to Resource Element, Multicarrier symbol Generation and Modulation and Upconversion.

### Embodiment 2

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 241 corresponds to the second node in the present application.

In one embodiment, the gNB 203 corresponds to the first node in the present application.

In one embodiment, the gNB 203 corresponds to the second node in the present application.

In one embodiment, the UE 241 corresponds to the first node in the present application.

In one embodiment, the UE 201 corresponds to the second node in the present application.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC sublayer 306.

In one embodiment, the first signaling in the present application is generated by the MAC sublayer 302.

In one embodiment, the first signaling in the present application is generated by the MAC sublayer 352.

In one embodiment, the first signaling in the present application is generated by the PHY 301.

In one embodiment, the first signaling in the present application is generated by the PHY 351.

In one embodiment, one of the M bit blocks in the present application is generated by the RRC sublayer 306.

In one embodiment, one of the M bit blocks in the present application is generated by the SDAP sub-layer 356.

In one embodiment, one of the M bit blocks in the present application is generated by the MAC sublayer 302.

In one embodiment, one of the M bit blocks in the present application is generated by the MAC sublayer 352.

In one embodiment, one of the M bit blocks in the present application is generated by the PHY 301.

In one embodiment, one of the M bit blocks in the present application is generated by the PHY 351.

In one embodiment, the first HARQ-ACK bit block in the present application is generated by the MAC sublayer 302.

In one embodiment, the first HARQ-ACK bit block in the present application is generated by the MAC sublayer 352.

In one embodiment, the first HARQ-ACK bit block in the present application is generated by the PHY 301.

In one embodiment, the first HARQ-ACK bit block in the present application is generated by the PHY 351.

In one embodiment, the first signal in the present application is generated by the PHY 301.

In one embodiment, the first signal in the present application is generated by the PHY 351.

### Embodiment 4

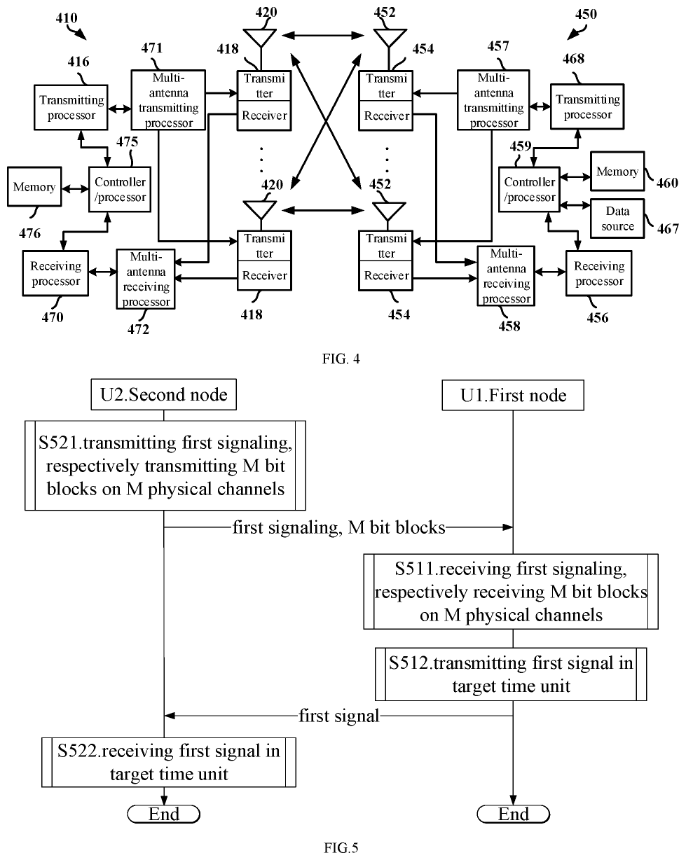

Embodiment 4 illustrates a schematic diagram of a first communication device and a second communication device in the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present application comprises the second communication device 450, and the second node in the present application comprises the first communication device 410.

In one subembodiment of the above embodiment, the first node is a UE, and the second node is a UE.

In one subembodiment of the above embodiment, the first node is a UE, and the second node is a relay node.

In one subembodiment of the above embodiment, the first node is a relay node, and the second node is a UE.

In one subembodiment of the above embodiment, the first node is a UE, and the second node is a base station.

In one subembodiment of the above embodiment, the first node is a relay node, and the second node is a base station.

In one subembodiment of the above embodiment, the second node is a UE, and the first node is a base station.

In one subembodiment of the above embodiment, the second node is a relay node, and the first node is a base station.

In one subembodiment of the above embodiment, the second communication device 450 comprises: at least one controller/processor; the at least one controller/processor is responsible for HARQ operation.

In one subembodiment of the above embodiment, the first communication device 410 comprises: at least one controller/processor; the at least one controller/processor is responsible for HARQ operation.

In one subembodiment of the above embodiment, the first communication device 410 comprises: at least one controller/processor; the at least one controller/processor is responsible for error detection using ACK and/or NACK protocols as a way to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives the first signaling in the present application; and respectively receives the M bit blocks in the present application on the M physical channels in the present application, M being a positive integer greater than 1; transmits the first signal in the present application in the target time window in the present application, and the first signal carries the first HARQ-ACK bit block in the present application; herein, the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling comprises configuration information of the M physical channels, and the configuration information comprises at least one of occupied time-domain resources, occupied frequency-domain resources, HARQ process number, RV or MCS; the first signaling indicates the first time-domain offset in the present application, and a latest physical channel accommodating the first-type bit block among the M physical layer channels is used together with the first time-domain offset to determine the target time unit.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving the first signaling in the present application; and respectively receiving M bit blocks in the present application on the M physical channels in the present application, M being a positive integer greater than 1; transmitting the first signal in the present application in the target time window in the present application, and the first signal carrying the first HARQ-ACK bit block in the present application; herein, the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling comprises configuration information of the M physical channels, and the configuration information comprises at least one of occupied time-domain resources, occupied frequency-domain resources, HARQ process number, RV or MCS; the first signaling indicates the first time-domain offset in the present application, and a latest physical channel accommodating the first-type bit block among the M physical layer channels is used together with the first time-domain offset to determine the target time unit.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits the first signaling in the present application; and respectively transmits the M bit blocks in the present application on the M physical channels in the present application, M being a positive integer greater than 1; receives the first signal in the present application in the target time window in the present application, and the first signal carries the first HARQ-ACK bit block in the present application; herein, the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling comprises configuration information of the M physical channels, and the configuration information comprises at least one of occupied time-domain resources, occupied frequency-domain resources, HARQ process number, RV or MCS; the first signaling indicates the first time-domain offset in the present application, and a latest physical channel accommodating the first-type bit block among the M physical layer channels is used together with the first time-domain offset to determine the target time unit.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting the first signaling in the present application; and respectively transmitting the M bit blocks in the present application on the M physical channels in the present application, M being a positive integer greater than 1; receiving the first signal in the present application in the target time window in the present application, and the first signal carrying the first HARQ-ACK bit block in the present application; herein, the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling comprises configuration information of the M physical channels, and the configuration information comprises at least one of occupied time-domain resources, occupied frequency-domain resources, HARQ process number, RV or MCS; the first signaling indicates the first time-domain offset in the present application, and a latest physical channel accommodating the first-type bit block among the M physical layer channels is used together with the first time-domain offset to determine the target time unit.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used to receive the first signaling in the present application.

In one embodiment, at least one of the antenna 420, the transmitter 418, the multi-antenna transmitting processor 471, the transmitting processor 416, the controller/processor 475, or the memory 476 is used to transmit the first signaling in the present application.

In one embodiment, at least one of the antenna 452, the receiver 454, the multi-antenna receiving processor 458, the receiving processor 456, the controller/processor 459, the memory 460, or the data source 467 is used to respectively receive the M bit blocks in the present application on the M physical channels in the present application.

In one embodiment, at least one of the antenna 420, the transmitter 418, the multi-antenna transmitting processor 471, the transmitting processor 416, the controller/processor 475, or the memory 476 is used to respectively transmit the M bit blocks in the present application on the M physical channel in the present application.

In one embodiment, at least one of the antenna 452, the transmitter 454, the multi-antenna transmission processor 458, the transmitting processor 468, the controller/processor 459, the memory 460, or the data source 467 is used to transmit the first signal in the present application in the target time unit in the present application.

In one embodiment, at least one of the antenna 420, the receiver 418, the multi-antenna receiving processor 472, the receiving processor 470, the controller/processor 475, or the memory 476 is used to receive the first signal in the present application in the target time unit in the present application.

### Embodiment 5

Embodiment 5 illustrates a flowchart of signal transmission according to one embodiment in the present application, as shown in FIG. 5. In FIG. 5, a first node U1 and a second node U2 are in communications via an air interface.

The first node U1 receives a first signaling in step S511, and respectively receives M bit blocks on the M physical channels; transmits a first signal in a target time unit in step S512.

The second node U2 transmits a first signaling in step S521, and respectively transmits M bit blocks on the M physical channels; receives a first signal in a target time unit in step S522.

In embodiment 5, M is a positive integer greater than 1; the first signal carries a first HARQ-ACK bit block; the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling indicates configuration information of the M physical channels, and the configuration information comprises at least one of occupied time-domain resources, occupied frequency-domain resources, HARQ process number, RV or MCS; the first signaling indicates a first time-domain offset, and a latest physical channel accommodating the first-type bit block among the M physical layer channels is used together with the first time-domain offset to determine the target time unit; the first signaling indicates HARQ process numbers corresponding to the M bit blocks, and which bit block in the M bit blocks is the first-type bit block is related to the HARQ process numbers corresponding to the M bit blocks; a HARQ process number corresponding to any of the M bit blocks belongs to a first HARQ process number set; a first HARQ process number subset is a proper subset of the first HARQ process number set; the first-type bit block refers to: a bit block with a HARQ process number belonging to the first HARQ process number subset; a number of time unit(s) between a start time of the target time unit and a start time of a time unit to which an end time of the latest physical channel accommodating the first-type bit block among the M physical channels in time domain belongs is equal to the first time-domain offset.

In one subembodiment of embodiment 5, HARQ process numbers in the first HARQ process number subset are all HARQ process numbers for enabled HARQ feedback, and any HARQ process number in the first HARQ process number set not belonging to the first HARQ process number subset is a HARQ process number for disabled HARQ feedback.

In one subembodiment of embodiment 5, the target time unit is earlier than a time unit to which an end time of one of the M physical channels in time domain belongs.

In one subembodiment of embodiment 5, a number of HARQ-ACK bit sub-block(s) comprised in the first HARQ-ACK bit block is related to the first HARQ process number subset; any HARQ-ACK bit sub-block in the first HARQ-ACK bit block is associated with at most one physical channel.

In one embodiment, the first node U1 is the first node in the present application.

In one embodiment, the second node U2 is the second node in the present application.

In one embodiment, the first node U1 is a UE.

In one embodiment, the first node U1 is a base station.

In one embodiment, the second node U2 is a base station.

In one embodiment, the second node U2 is a UE.

In one embodiment, an air interface between the second node U2 and the first node U1 is a Uu interface.

In one embodiment, an air interface between the second node U2 and the first node U1 comprises a cellular link.

In one embodiment, an air interface between the second node U2 and the first node U1 is a PC5 interface.

In one embodiment, an air interface between the second node U2 and the first node U1 comprises a sidelink.

In one embodiment, an air interface between the second node U2 and the first node U1 comprises a radio interface between a base station and a UE.

In one embodiment, an air interface between the second node U2 and the first node U1 comprises a radio interface between a UE and a UE.

In one embodiment, the first signaling is received/transmitted before the M bit blocks.

In one embodiment, the first signaling is received/transmitted before any of the M bit blocks.

In one embodiment, a reception/transmission of the first signaling is not later than a reception/transmission of the M bit blocks.

In one embodiment, when the first node receives a bit block corresponding to a HARQ process number of HARQ feedback enabling scheduled by a DCI, the first node performs a HARQ feedback operation on a bit block corresponding to a HARQ process number of HARQ feedback enabling; when the first node receives a bit block corresponding to a HARQ process number of HARQ feedback disabling scheduled by a DCI, the first node drops executing a HARQ feedback operation on a bit block corresponding to a HARQ process number of HARQ feedback disabling.

In one embodiment, HARQ process numbers in the first HARQ process number subset are all HARQ process numbers of HARQ feedback disabling, and any HARQ process number in the first HARQ process number set not belonging to the first HARQ process number subset is a HARQ process number for disabled HARQ feedback.

### Embodiment 6

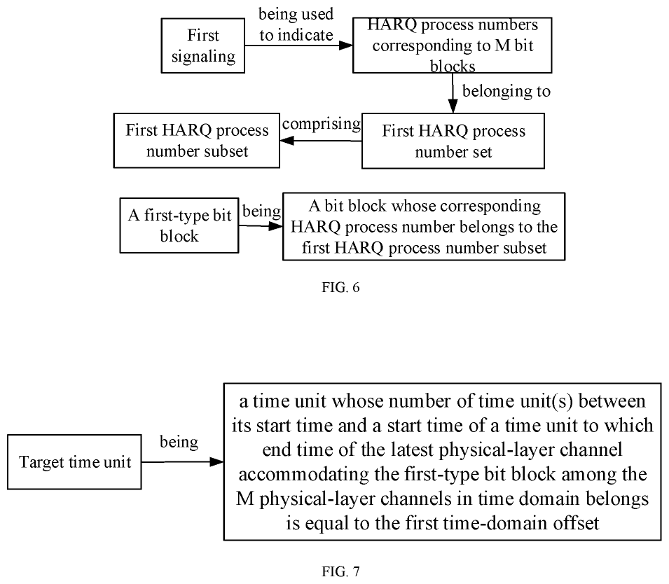

Embodiment 6 illustrates a schematic diagram of relations among a first signaling, HARQ process numbers corresponding to M bits, a first HARQ process number set, a first HARQ process number subset and a first-type bit block according to one embodiment of the present application, as shown in FIG. 6.

In embodiment 6, a first signaling is used to indicate a HARQ process number corresponding to M bit blocks, and a HARQ process number corresponding to any of the M bit blocks belongs to a first HARQ process number set; a first HARQ process number subset is a proper subset of the first HARQ process number set; a first-type bit block is: the corresponding HARQ process number belongs to a bit block of the first HARQ process number subset.

In one embodiment, for any the first-type bit block in the M bit blocks, the corresponding HARQ process number belongs to the first HARQ process number subset.

In one embodiment, when a HARQ process number corresponding to a bit block does not belong to the first HARQ process number subset, the bit block is not the first-type bit block.

In one embodiment, when a HARQ process number corresponding to a bit block does not belong to the first HARQ process number subset, the bit block is the second-type bit block in the present application.

In one embodiment, in the present application, the HARQ process number corresponding to a bit block is: a HARQ process number of a HARQ process associated with a physical channel used to accommodate the bit block.

In one embodiment, in the present application, the HARQ process number corresponding to a bit block is: a HARQ process number applied to a physical channel accommodating the bit block.

In one embodiment, HARQ-ACK information bits for any first-type bit block in the M bit blocks are transmitted in the target time unit.

In one embodiment, a HARQ-ACK information bit for at least the first-type bit block in the M bit blocks is transmitted in the target time unit.

In one embodiment, the first signaling explicitly indicates HARQ process numbers corresponding to the M bit blocks.

In one embodiment, the first signaling implicitly indicates HARQ process numbers corresponding to the M bit blocks.

In one embodiment, the meaning of the first signaling indicating the HARQ process numbers corresponding to the M bit blocks comprises: a HARQ process number corresponding to an earliest received bit block among the M bit blocks is equal to a value indicated by the first signaling, and a HARQ process number corresponding to a bit block other than the earliest received bit block in the M bit blocks is inferred based on the value indicated by the first signaling.

In one subembodiment of the above embodiment, the value indicated by the first signaling is: a value indicated by a HARQ process number field comprised in the first signaling.

In one embodiment, according to the scheduling order, the M bit blocks sequentially comprise bit block #1, bit block #2, . . . , bit block #M; the first signaling indicates a first reference HARQ process number; for any positive integer i not greater than M, a HARQ process number corresponding to bit block #i in the M bit blocks is equal to a result of modulo a first intermediate value over a second intermediate value, and the first intermediate value is equal to the first reference HARQ process number plus i minus 1.

In one subembodiment of the above embodiment, the second intermediate value is equal to a total number of HARQ process number(s) comprised in the first HARQ process number set in the present application.

In one subembodiment of the above embodiment, the second intermediate value is equal to 16.

In one subembodiment of the above embodiment, the second intermediate value is equal to 32.

In one subembodiment of the above embodiment, the second intermediate value is equal to 64.

In one subembodiment of the above embodiment, the second intermediate value is equal to 128.

In one subembodiment of the above embodiment, the second intermediate value is equal to 256.

In one subembodiment of the above embodiment, the second intermediate value is determined based on a configuration of a higher-layer signaling.

In one embodiment, the first HARQ process number set comprises K HARQ process number(s), K being a positive integer.

In one embodiment, the first HARQ process number set comprises 0, 1, K−1.

In one embodiment, the first HARQ process number set comprises 1, 2, . . . , K.

In one embodiment, K is equal to 1.

In one embodiment, K is equal to 2.

In one embodiment, K is equal to 4.

In one embodiment, K is equal to 7.

In one embodiment, K is equal to 8.

In one embodiment, K is not greater than 16.

In one embodiment, K is not greater than 32.

In one embodiment, K is not greater than 64.

In one embodiment, K is not greater than 128.

In one embodiment, K is not greater than 256.

In one embodiment, K is not greater than 1024.

In one embodiment, the first HARQ process number set is predefined.

In one embodiment, the first HARQ process number set is configured by an RRC signaling.

In one embodiment, the first HARQ process number set is configured by a MAC CE signaling.

In one embodiment, the first HARQ process number set is configured by a higher-layer signaling.

In one embodiment, the first HARQ process number subset is configured by an RRC signaling.

In one embodiment, the first HARQ process number subset is configured by a MAC CE signaling.

In one embodiment, the first HARQ process number subset is configured by a higher-layer signaling.

### Embodiment 7

Embodiment 7 illustrates a schematic diagram of a target time unit according to one embodiment of the present application, as shown in FIG. 7.

In embodiment 7, a target time unit is: a time unit whose number of time unit(s) between its start time and a start time of a time unit to which an end time of the latest physical channel accommodating the first-type bit block among the M physical channels in the present application in time domain belongs is equal to a time unit of a first time-domain offset.

In one embodiment, a time unit to which an end time of the latest physical channel accommodating a first-type bit block among the M physical channels in time domain belongs is time unit n, the first time-domain offset is equal to k, and the time unit is time unit n+k, k being a non-negative integer.

In one subembodiment of the above embodiment, both n and n+k are indexes of time units.

In one embodiment, the time unit in the present application is a slot.

In one embodiment, the time unit in the present application is a sub-slot.

In one embodiment, the time unit in the present application is a multicarrier symbol.

In one embodiment, the time unit in the present application comprises at least one multicarrier symbol.

In one embodiment, the multicarrier symbol in the present application is an Orthogonal Frequency Division Multiplexing (OFDM) symbol.

In one embodiment, the multicarrier symbol in the present application is a Single Carrier-Frequency Division Multiple Access (SC-FDMA) symbol.

In one embodiment, the multicarrier symbol in the present application is a Discrete Fourier Transform Spread OFDM (DFT-S-OFDM) symbol.

In one embodiment, the multi-carrier symbol in the present application is a Filter Bank Multi-Carrier (FBMC) symbol.

In one embodiment, the multicarrier symbol in the present application comprises a Cyclic Prefix (CP).

In one embodiment, the time unit in the present application is a time unit corresponding to a subcarrier spacing (SCS) configuration of a carrier used for transmitting the first signal.

In one embodiment, the time unit in the present application is a time unit corresponding to a subcarrier spacing (SCS) configuration of a Bandwidth Part (BWP) used for transmitting the first signal.

In one embodiment, the first time-domain offset is equal to or greater than 0.

In one embodiment, when the first time-domain offset is equal to 0, the target time unit is a time unit to which an end time of the latest physical channel accommodating the first-type bit block among the M physical channels in time domain belongs; when the first time-domain offset is greater than 0, the target time unit is after a time unit to which an end time of the latest physical channel accommodating the first-type bit block among the M physical channels in time domain belongs.

In one embodiment, the target time unit is not earlier than a time unit to which an end time of the latest physical channel accommodating the first-type bit among the M physical channel belongs in time domain.

In one embodiment, the end time of the latest physical channel accommodating the first-type bit block among the M physical channels in time domain is: a corresponding end time of a PDSCH reception.

### Embodiment 8

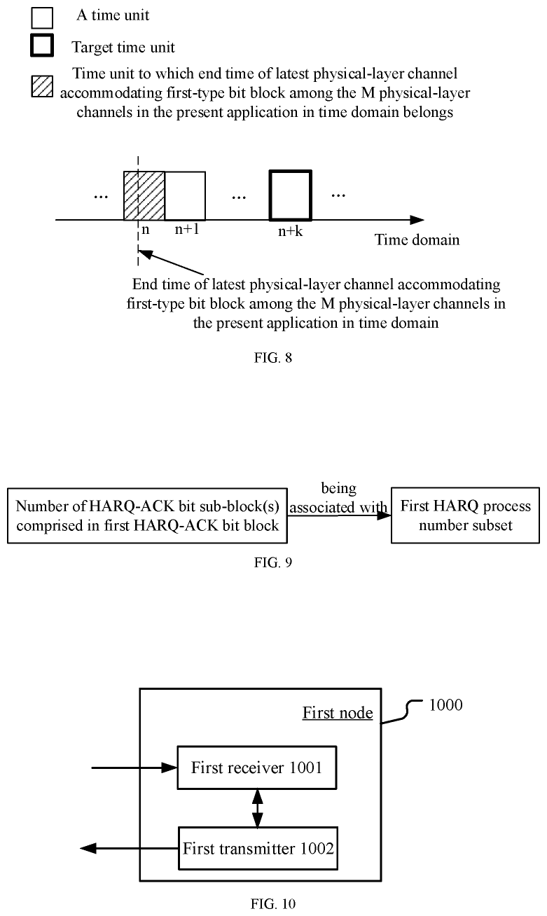

Embodiment 8 illustrates a schematic diagram of a target time unit according to one embodiment of the present application, as shown in FIG. 8. In FIG. 8, a box represents a time unit, the slash-filled box represents a time unit to which an end time of a latest physical channel accommodating a first-type bit block among the M physical channels in time domain belongs, and the bolded box represents a target time unit.

In embodiment 8, a time unit to which an end time of a latest physical channel accommodating a first-type bit block among the M physical channel in the present application in time domain belongs is time unit n, a first time-domain offset is equal to k, and a target time unit is time unit n+k.

### Embodiment 9

Embodiment 9 illustrates a schematic diagram of a relation between a number of HARQ-ACK bit sub-block(s) comprised in a first HARQ-ACK bit block and a first HARQ process number subset according to one embodiment of the present application, as shown in FIG. 9.

In embodiment 9, a number of HARQ-ACK bit sub-block(s) comprised in a first HARQ-ACK bit block is related to a first HARQ process number subset; any HARQ-ACK bit sub-block in the first HARQ-ACK bit block is associated with at most one physical channel.

In one embodiment, the HARQ-ACK bit sub-block in the first HARQ-ACK bit block comprises at least one bit.

In one embodiment, the HARQ-ACK bit sub-block in the first HARQ-ACK bit block comprises at least one HARQ-ACK information bit.

In one embodiment, any HARQ-ACK bit sub-block in the first HARQ-ACK bit block is associated with only one physical channel.

In one embodiment, any HARQ-ACK bit sub-block in the first HARQ-ACK bit block is associated with at most one PDSCH.

In one embodiment, any HARQ-ACK bit sub-block in the first HARQ-ACK bit block is associated with only one PDSCH.

In one embodiment, a number of HARQ-ACK bit sub-block(s) comprised in the first HARQ-ACK bit block is linearly correlated to the first HARQ process number subset.

In one embodiment, a number of HARQ-ACK bit sub-block(s) comprised in the first HARQ-ACK bit block is equal to a number of HARQ process number(s) comprised in the first HARQ process number subset.

In one embodiment, a number of HARQ-ACK bit sub-block(s) comprised in the first HARQ-ACK bit block is not greater than a number of HARQ process number(s) comprised in the first HARQ process number subset.

In one embodiment, a first HARQ process number sequence comprises K sequentially increasing HARQ process numbers, where K is a positive integer; a first HARQ process number subsequence group comprises K−L+1 HARQ process number subsequences, and L is not greater than the K; for any positive integer i not greater than K−L+1, an i-th HARQ process number subsequence in the first HARQ process number subsequence group consists of continuous L HARQ process numbers starting from an i-th HARQ process number in the first HARQ process number sequence, and a number of HARQ process number(s) belonging to the first HARQ process number subset comprised in the i-th HARQ process number subsequence of the first HARQ process number subsequence group is equal to Nᵢ; the number of HARQ-ACK bit sub-blocks comprised in the first HARQ-ACK bit block is equal to a maximum value in N₁, N₂, . . . , N_{K-L+1}.

In one embodiment, a first HARQ process number sequence comprises K sequentially increasing HARQ process numbers, where K is a positive integer; a first HARQ process number subsequence group comprises (L−1) mod (K−1)+(K−L+1) HARQ process number subsequence(s), where L is a positive integer not greater than K; for any positive integer i not greater than (L−1) mod (K−1)+(K−L+1), an i-th HARQ process number subsequence in the first HARQ process number subsequence group consists of continuous L HARQ process numbers starting from an i-th HARQ process number in the first HARQ process number sequence, and a number of HARQ process number(s) belonging to the first HARQ process number subset comprised in the i-th HARQ process number subsequence of the first HARQ process number subsequence group is equal to Nᵢ; the number of HARQ-ACK bit sub-blocks comprised in the first HARQ-ACK bit block is equal to a maximum value in N₁, N₂, . . . , N_{(L-1) mod (K-1)+(K-L+1)}.

In one embodiment, L is configured based on a higher-layer signaling.

In one embodiment, L is inferred based on a configuration of a higher-layer signaling.

In one embodiment, L is a positive integer related to a slot timing value.

In one embodiment, the first HARQ process number sequence is a sequence obtained by arranging HARQ process numbers in ascending order in the first HARQ process number set in the present application.

### Embodiment 10

Embodiment 10 illustrates a structural block diagram of a processor in a first node, as shown in FIG.

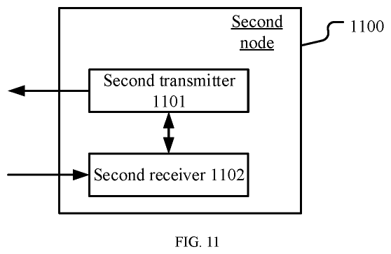

In FIG. 10, a processor 1000 in a first node comprises a first receiver 1001 and a first transmitter 1002.

In one embodiment, the first node 1000 is a UE.

In one embodiment, the first node 1000 is a relay node.

In one embodiment, the first node 1000 is a vehicle-mounted communication device.

In one embodiment, the first node 1000 is a UE that supports V2X communications.

In one embodiment, the first node 1000 is a relay node that supports V2X communications.

In one embodiment, the first receiver 1001 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1001 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1001 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1001 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1001 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1002 comprises at least one of the antenna 452, the transmitter 454, the multi-antenna transmitting processor 457, the transmitting processor 468, the controller/processor 459, the memory 460, or the data source 467 in FIG. 4 of the present application.

In one embodiment, the first transmitter 1002 comprises at least the first five of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1002 comprises at least the first four of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1002 comprises at least the first three of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1002 comprises at least the first two of the antenna 452, the transmitter 454, the multi-antenna transmitting processor 457, the transmitting processor 468, the controller/processor 459, the memory 460, and the data source 467 in FIG. 4 of the present application.

In Embodiment 10, the first receiver 1001 receives a first signaling; respectively receives M bit blocks on the M physical channels, M being a positive integer greater than 1; the first transmitter 1002 transmits a first signal in a target time unit, the first signal carries a first HARQ-ACK bit block; herein, the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling indicates configuration information of the M physical channels, and the configuration information comprises at least one of occupied time-domain resources, occupied frequency-domain resources, HARQ process number, RV or MCS; the first signaling indicates a first time-domain offset, and a latest physical channel accommodating the first-type bit block among the M physical layer channels is used together with the first time-domain offset to determine the target time unit.

In one embodiment, the first signaling indicates HARQ process numbers corresponding to the M bit blocks, and which bit block in the M bit blocks is the first-type bit block is related to the HARQ process numbers corresponding to the M bit blocks.

In one embodiment, a HARQ process number corresponding to any of the M bit blocks belongs to a first HARQ process number set; a first HARQ process number subset is a proper subset of the first HARQ process number set; the first-type bit block refers to: a bit block with a HARQ process number belonging to the first HARQ process number subset.

In one embodiment, HARQ process numbers in the first HARQ process number subset are all HARQ process numbers for enabled HARQ feedback, and any HARQ process number in the first HARQ process number set not belonging to the first HARQ process number subset is a HARQ process number for disabled HARQ feedback.

In one embodiment, a number of time unit(s) between a start time of the target time unit and a start time of a time unit to which an end time of the latest physical channel accommodating the first-type bit block among the M physical channels in time domain belongs is equal to the first time-domain offset.

In one embodiment, the target time unit is earlier than a time unit to which an end time of one of the M physical channels in time domain belongs.

In one embodiment, a number of HARQ-ACK bit sub-block(s) comprised in the first HARQ-ACK bit block is related to the first HARQ process number subset; any HARQ-ACK bit sub-block in the first HARQ-ACK bit block is associated with at most one physical channel.

### Embodiment 11

Embodiment 11 illustrates a structure block diagram of a processor in a second node, as shown in FIG. 11. In FIG. 11, a processor 1100 in a second node comprises a second transmitter 1101 and a second receiver 1102.

In one embodiment, the second node 1100 is a UE.

In one embodiment, the second node 1100 is a base station.

In one embodiment, the second node 1100 is a relay node.

In one embodiment, the second node 1100 is a vehicle-mounted communication device.

In one embodiment, the second node 1100 is a UE supporting V2X communications.

In one embodiment, the second transmitter 1101 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1101 comprises at least first five of the antenna 420, the transmitter 418, the multi-antenna transmitting processor 471, the transmitting processor 416, the controller/processor 475 and the memory 476 in FIG. 4 of the present application.

In one embodiment, the second transmitter 1101 comprises at least first four of the antenna 420, the transmitter 418, the multi-antenna transmitting processor 471, the transmitting processor 416, the controller/processor 475 and the memory 476 in FIG. 4 of the present application.

In one embodiment, the second transmitter 1101 comprises at least first three of the antenna 420, the transmitter 418, the multi-antenna transmitting processor 471, the transmitting processor 416, the controller/processor 475 and the memory 476 in FIG. 4 of the present application.

In one embodiment, the second transmitter 1101 comprises at least first two of the antenna 420, the transmitter 418, the multi-antenna transmitting processor 471, the transmitting processor 416, the controller/processor 475 and the memory 476 in FIG. 4 of the present application.

In one embodiment, the second receiver 1102 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1102 comprises at least first five of the antenna 420, the receiver 418, the multi-antenna receiving processor 472, the receiving processor 470, the controller/processor 475 and the memory 476 in FIG. 4 of the present application.

In one embodiment, the second receiver 1102 comprises at least first four of the antenna 420, the receiver 418, the multi-antenna receiving processor 472, the receiving processor 470, the controller/processor 475 and the memory 476 in FIG. 4 of the present application.

In one embodiment, the second receiver 1102 comprises at least first three of the antenna 420, the receiver 418, the multi-antenna receiving processor 472, the receiving processor 470, the controller/processor 475 and the memory 476 in FIG. 4 of the present application.

In one embodiment, the second receiver 1102 comprises at least first two of the antenna 420, the receiver 418, the multi-antenna receiving processor 472, the receiving processor 470, the controller/processor 475 and the memory 476 in FIG. 4 of the present application.

In embodiment 11, the second transmitter 1101 transmits a first signaling; respectively transmits M bit blocks on the M physical channels, M being a positive integer greater than 1; the second receiver 1102 receives a first signal in a target time unit, the first signal carries a first HARQ-ACK bit block; herein, the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling indicates configuration information of the M physical channels, and the configuration information comprises at least one of occupied time-domain resources, occupied frequency-domain resources, HARQ process number, RV or MCS; the first signaling indicates a first time-domain offset, and a latest physical channel accommodating the first-type bit block among the M physical layer channels is used together with the first time-domain offset to determine the target time unit.

In one embodiment, the first signaling indicates HARQ process numbers corresponding to the M bit blocks, and which bit block in the M bit blocks is the first-type bit block is related to the HARQ process numbers corresponding to the M bit blocks.

In one embodiment, a HARQ process number corresponding to any of the M bit blocks belongs to a first HARQ process number set; a first HARQ process number subset is a proper subset of the first HARQ process number set; the first-type bit block refers to: a bit block with a HARQ process number belonging to the first HARQ process number subset.

In one embodiment, HARQ process numbers in the first HARQ process number subset are all HARQ process numbers for enabled HARQ feedback, and any HARQ process number in the first HARQ process number set not belonging to the first HARQ process number subset is a HARQ process number for disabled HARQ feedback.

In one embodiment, a number of time unit(s) between a start time of the target time unit and a start time of a time unit to which an end time of the latest physical channel accommodating the first-type bit block among the M physical channels in time domain belongs is equal to the first time-domain offset.

In one embodiment, the target time unit is earlier than a time unit to which an end time of one of the M physical channels in time domain belongs.

In one embodiment, a number of HARQ-ACK bit sub-block(s) comprised in the first HARQ-ACK bit block is related to the first HARQ process number subset; any HARQ-ACK bit sub-block in the first HARQ-ACK bit block is associated with at most one physical channel.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, tele-controlled aircrafts and other wireless communication devices. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, tele-controlled aircrafts and other wireless communication devices. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, tele-controlled aircrafts, etc. The base station or network side equipment in the present application includes but is not limited to macro-cellular base stations, micro-cellular base stations, home base stations, relay base station, eNB, gNB, Transmitter Receiver Point (TRP), GNSS, relay satellites, satellite base stations, space base stations, test device, test equipment, test instrument and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling; respectively receiving M bit blocks on M physical channels, M being a positive integer greater than 1; and
a first transmitter, transmitting a first signal in a target time unit, the first signal carrying a first HARQ-ACK bit block;
wherein the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is correctly received; the first signaling indicates configuration information of the M physical channels, and the configuration information comprises at least one of occupied time-domain resources, occupied frequency-domain resources, HARQ process number, RV or MCS; the first signaling indicates a first time-domain offset, and a latest physical channel accommodating the first-type bit block among the M physical layer channels is used together with the first time-domain offset to determine the target time unit.

2. The first node according to claim 1, wherein the first signaling indicates HARQ process numbers corresponding to the M bit blocks, and which bit block in the M bit blocks is the first-type bit block is related to the HARQ process numbers corresponding to the M bit blocks.

3. The first node according to claim 1, wherein a HARQ process number corresponding to any of the M bit blocks belongs to a first HARQ process number set; a first HARQ process number subset is a proper subset of the first HARQ process number set; the first-type bit block refers to: a bit block with a HARQ process number belonging to the first HARQ process number subset.

4. The first node according to claim 3, wherein HARQ process numbers in the first HARQ process number subset are all HARQ process numbers for enabled HARQ feedback, and any HARQ process number in the first HARQ process number set not belonging to the first HARQ process number subset is a HARQ process number for disabled HARQ feedback.

5. The first node according to claim 1, wherein a number of time unit(s) between a start time of the target time unit and a start time of a time unit to which an end time of the latest physical channel accommodating the first-type bit block among the M physical channels in time domain belongs is equal to the first time-domain offset.

6. The first node according to claim 1, wherein the target time unit is earlier than a time unit to which an end time of one of the M physical channels in time domain belongs.

7. The first node according to claim 3, wherein a number of HARQ-ACK bit sub-block(s) comprised in the first HARQ-ACK bit block is related to the first HARQ process number subset; any HARQ-ACK bit sub-block in the first HARQ-ACK bit block is associated with at most one physical channel.

8. A second node for wireless communications, comprising:
a second transmitter, transmitting a first signaling; respectively transmitting the M bit blocks on the M physical channels, M being a positive integer greater than 1; and
a second receiver, receiving a first signal in a target time unit, the first signal carrying a first HARQ-ACK bit block;
wherein the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling indicates configuration information of the M physical channels, and the configuration information comprises at least one of occupied time-domain resources, occupied frequency-domain resources, HARQ process number, RV or MCS; the first signaling indicates a first time-domain offset, and a latest physical channel accommodating the first-type bit block among the M physical layer channels is used together with the first time-domain offset to determine the target time unit.

9. The second node according to claim 8, wherein the first signaling indicates HARQ process numbers corresponding to the M bit blocks, and which bit block in the M bit blocks is the first-type bit block is related to the HARQ process numbers corresponding to the M bit blocks.

10. The second node according to claim 8, wherein a HARQ process number corresponding to any of the M bit blocks belongs to a first HARQ process number set; a first HARQ process number subset is a proper subset of the first HARQ process number set; the first-type bit block refers to: a bit block with a HARQ process number belonging to the first HARQ process number subset.

11. The second node according to claim 10, wherein HARQ process numbers in the first HARQ process number subset are all HARQ process numbers for enabled HARQ feedback, and any HARQ process number in the first HARQ process number set not belonging to the first HARQ process number subset is a HARQ process number for disabled HARQ feedback.

12. The second node according to claim 10, wherein a number of time unit(s) between a start time of the target time unit and a start time of a time unit to which an end time of the latest physical channel accommodating the first-type bit block among the M physical channels in time domain belongs is equal to the first time-domain offset;
or, wherein the target time unit is earlier than a time unit to which an end time of one of the M physical channels in time domain belongs;
or, wherein a number of HARQ-ACK bit sub-block(s) comprised in the first HARQ-ACK bit block is related to the first HARQ process number subset; any HARQ-ACK bit sub-block in the first HARQ-ACK bit block is associated with at most one physical channel.

13. A method in a first node for wireless communications, comprising:
receiving a first signaling; respectively receiving M bit blocks on M physical channels, M being a positive integer greater than 1; and
transmitting a first signal in a target time unit, the first signal carrying a first HARQ-ACK bit block;
wherein the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling indicates configuration information of the M physical channels, and the configuration information comprises at least one of occupied time-domain resources, occupied frequency-domain resources, HARQ process number, RV or MCS; the first signaling indicates a first time-domain offset, and a latest physical channel accommodating the first-type bit block among the M physical layer channels is used together with the first time-domain offset to determine the target time unit.

14. The method in a first node according to claim 13, wherein the first signaling indicates HARQ process numbers corresponding to the M bit blocks, and which bit block in the M bit blocks is the first-type bit block is related to the HARQ process numbers corresponding to the M bit blocks.

15. The method in a first node according to claim 13, wherein a HARQ process number corresponding to any of the M bit blocks belongs to a first HARQ process number set; a first HARQ process number subset is a proper subset of the first HARQ process number set; the first-type bit block refers to: a bit block with a HARQ process number belonging to the first HARQ process number subset.

16. The method in a first node according to claim 15, wherein HARQ process numbers in the first HARQ process number subset are all HARQ process numbers for enabled HARQ feedback, and any HARQ process number in the first HARQ process number set not belonging to the first HARQ process number subset is a HARQ process number for disabled HARQ feedback.

17. The method in a first node according to claim 13, wherein a number of time unit(s) between a start time of the target time unit and a start time of a time unit to which an end time of the latest physical channel accommodating the first-type bit block among the M physical channels in time domain belongs is equal to the first time-domain offset.

18. The method in a first node according to claim 13, wherein the target time unit is earlier than a time unit to which an end time of one of the M physical channels in time domain belongs.

19. The method in a first node according to claim 15, wherein a number of HARQ-ACK bit sub-block(s) comprised in the first HARQ-ACK bit block is related to the first HARQ process number subset; any HARQ-ACK bit sub-block in the first HARQ-ACK bit block is associated with at most one physical channel.

20. A method in a second node for wireless communications, comprising:
transmitting a first signaling; respectively transmitting the M bit blocks on the M physical channels, M being a positive integer greater than 1; and
receiving a first signal in a target time unit, the first signal carrying a first HARQ-ACK bit block;
wherein the first signaling is used to indicate first-type bit block(s) in the M bit blocks, and a number of the first-type bit block(s) in the M bit blocks is a positive integer less than M; the M physical channels are mapped to transport channel(s) of a same type; the first HARQ-ACK bit block is used to indicate whether the first-type bit block(s) in the M bit blocks is(are) correctly received; the first signaling indicates configuration information of the M physical channels, and the configuration information comprises at least one of occupied time-domain resources, occupied frequency-domain resources, HARQ process number, RV or MCS; the first signaling indicates a first time-domain offset, and a latest physical channel accommodating the first-type bit block among the M physical layer channels is used together with the first time-domain offset to determine the target time unit.
